(19) United States
(12) Patent Application Publication
(10) Pub. No.: US 2001/0056503 A1
(43) Pub. Date: Dec. 27, 2001

(54) Network interface device having primary and backup interfaces for automatic dial backup upon loss of a primary connection and method of using same

(76) Inventor: Richard J. Hibbard, Bradenton, FL (US)

Correspondence Address: Proskauer Rose LLP, Patent Department, 1585 Broadway, New York, NY, 10036, US

(21) Appl. No.: 09/844,291

(22) Filed: Apr. 27, 2001

Related U.S. Application Data
(60) Provisional application No. 60/199,995, filed on Apr. 27, 2000.

(51) Int. Cl. G06F 15/16

(52) U.S. Cl. 709/250; 709/227

(57) ABSTRACT

A network interface device to connect a network to a virtual private network comprises a primary interface to a public network, such as an Ethernet interface to a WAN or the Internet, and a secondary, back-up interface to the public network. The secondary back-up connection is activated automatically when the primary connection fails. The network interface device may be provided with further functionality that enables secure communication over both the primary and secondary connection

### RELATED APPLICATION

This application is related to and claims the benefit of U.S. provisional patent application Ser. No. 60/199,995, filed Apr. 27, 2000 and entitled Automatic Dial Backup/Network Failover. The content of this provisional application is incorporated herein by reference.

### FIELD OF THE INVENTION

The present invention is directed to a network interface device and method for automatically activating a back-up connection between the network interface device and a public network when a primary connection fails. The present invention has particular applicability to secure communications networks, such as a Virtual Private Network (VPN).

### BACKGROUND OF THE INVENTION

A VPN is a network that is deployed over some type of shared infrastructure, such as a WAN or the Internet, that is normally available to the public. Nonetheless, a VPN can be securely used to link private resources at nodes of the VPN without giving the public access to the VPN network. Such a node may comprise a single computer that links over the VPN to a network or, more typically, the node may be a network of computers that links with another network of computers. A VPN is useful because nodes (i.e. computer on networks) in different locations can be linked via the public infrastructure instead of over expensive, privately-leased lines. Thus, for example, a company having offices in different buildings, cities, or countries can avoid the expense of maintaining its own leased lines to link the various pieces of its network, and could instead securely use the public network as the link.

The use of any tunneling protocol, such as IPSec (Secure Internet Protocol), makes it possible to create the VPN through “tunnels” over the Internet. “Tunneling” involves encapsulating data packets in a network protocol within TCP/IP packets. The network protocol is known at the entry and exit points, or “tunnel interfaces,” of a given network, but not on the public network so that if the packets are intercepted the data within them remains secure. The tunnel interface itself is similar to a hardware interface, but is configured in software.

As with all networks, it is important to maintain the network connection between the nodes of a VPN at all times. The nodes are typically reliably linked to the WAN or Internet with Ethernet connections. However, a node's Ethernet connection to the WAN or Internet can fail either because the public interface on a network interface device between the network and gateway goes down or because the primary WAN or Internet gateway used by the device goes down. In either case, the node remains unconnected to the rest of the network until the connection is restored at some future point, which may take a while. Alternatively, the connection of the node to the rest of the network may be manually rerouted through an alternate connection, which is time consuming and requires a network administrator to first recognize that the connection has been lost.

While loss of a connection to a public infrastructure like the Internet is especially significant for VPN'S, it is also a problem for all networks that utilize resources on a public network like the Internet. When the connection to the Internet is down, the resources on the Internet cannot be accessed.

### SUMMARY OF THE INVENTION

It is therefore an object of the present invention to provide a network interface device and method for automatically activating a back-up connection should the primary connection fail. This minimizes the overall downtime until the primary interface is restored.

It is a further object of the present invention to enable a back-up connection which only requires a minimum of additional processing and network overhead.

These objectives are achieved in accordance with an embodiment of the present invention in which a network interface device is provided. The device comprises a private interface for connecting to one of a computer and network of computers, a primary public interface for a public network, such as a WAN or the Internet, and a back-up public interface for connecting to the public network using a secondary connection, such as a dial-up connection to an Internet Service Provider (ISP). The network device automatically activates the back-up connection when the primary connection fails for whatever reason using a software application executable at the network interface device.

The status of the primary connection is monitored, such as by sending ICMP pings over the primary public interface to a target IP address on the public network. If the primary connection fails, the secondary connection is established and is maintained until the primary connection is restored. The restoration of the primary connection may be determined by pinging the target IP address through the back-up connection. When the primary connection becomes available, it may be automatically or manually restored. Where the network interface device connects to a VPN, the device also generally comprises encryption and compression utilities and other functionality that enables secure private communications to take place over the public network.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings, wherein like reference numerals denote similar elements through out the several views:

FIG. 1 is a block diagram depicting an example of a virtual private network that has both a primary Ethernet connection between two nodes and a back-up modem connection;

FIG. 2 is a block diagram of some of the basic components of the network interface device in accordance with an embodiment of the present invention;

FIG. 3 is a flow chart of an algorithm for automatically switching to a back-up connection when the primary connection fails and for automatically restoring the primary connection when it becomes available again; and

FIG. 4 is a flow chart detailing the algorithm that is performed at step 250 of FIG. 3.

### DETAILED DESCRIPTION OF THE PREFERRED EMBODIMENTS

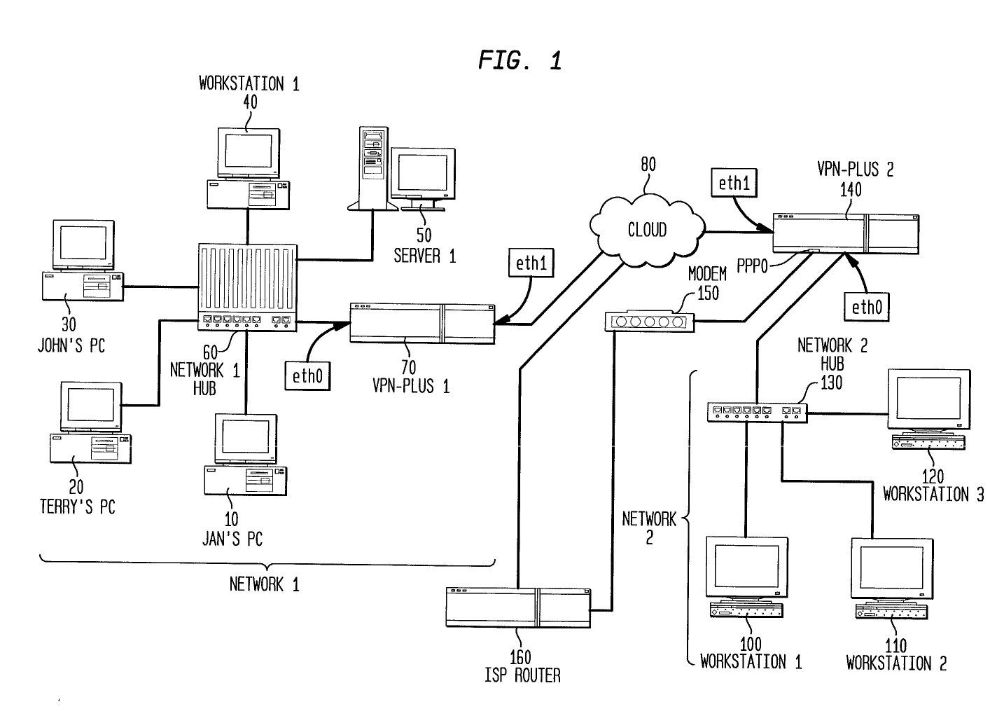

FIG. 1 shows an example of a VPN in accordance with the present invention. In this example, a first network Network 1 comprises a node with multiple computers 10, 20, 30, a workstation 40, and a server 50 all linked to a hub 60. A network interface device 70 provides a first, private Ethernet interface eth0 to hub 60 and a second, public Ethernet interface eth1 to a VPN cloud 80 (e.g., a communications network). Eth0 may be a standard IEEE 802.3 Ethernet gateway. Device 70 provides hardware and software for implementing VPN functionality over a public network, such as the Internet or WAN. The functionality may include high-speed point-to-point encryption and compression of data, data integrity checking, hardware authentication, key management, secure gateway administration, a firewall for network security, routing protocols, key management, etc. One group of devices that offer all or some of this functionality are the Net Fortress family of products from Fortress Technologies, Inc. of Oldsmar, Fla. Network 1, as illustrated, does not have a secondary back-up interface to cloud 80, although it could.

A second node of the VPN comprises a network Network 2 comprising three workstations 100, 110, 120 connected to a hub 130. Hub 130 connects to a second network interface device 140 provided for Network 2 at a private eth0 interface on device 140. Device 140 connects to cloud 80 at a public eth1 interface, which also may be a standard 802.3 Ethernet gateway. A secondary back-up interface ppp0 is provided for Network 2 to connect to cloud 80 using a high-speed modem 150. Secondary interface ppp0 is a high-speed serial PPP (point-to-point protocol) interface to an ISP router 160 that links to cloud 80. It is this secondary ppp0 interface that provides the back-up connection for Network 2 to cloud 80. It should be understood that while a dial-up connection using modem 150 is shown as an illustrative example, any type of secondary connection may be used. Modem 150 is given as an example because it is a relatively simple device to implement and oftentimes network interface device 140 has an existing serial port to which a modem can easily interface.

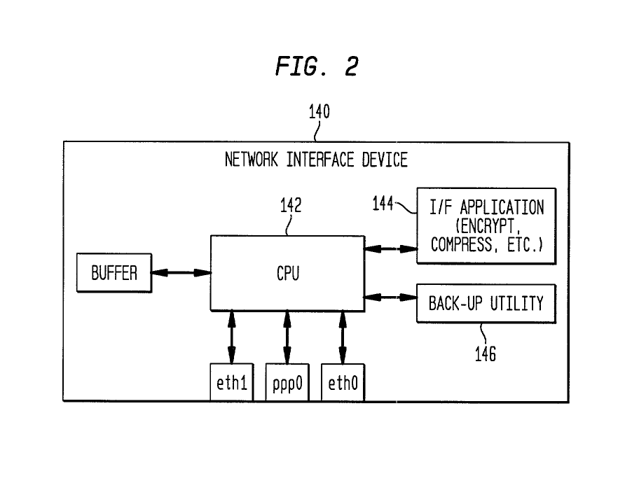

FIG. 2 illustrates some of the basic components of network interface device 140 including central processing unit 142, an interface software application 144 that provides the device functionality, the back-up utility 146, and a buffer 148. The backup utility 146, which may run in the background and may be implemented as a stand-alone utility, comprises a PPPD daemon for polling the primary connection for possible failures , a BackUp daemon for automatically switching to a secondary connection using the backup ppp0 interface if a failure is detected, and an optional Failover daemon for automatically restoring the primary connection through the eth1 interface when the primary connection is restored.

The dial backup utility 146 monitors the status (UP or DOWN) of the primary connection that is established between the eth1 interface and the router or gateway interface that is closest to device. The failure of the primary connection may be caused by one or more problems, such as a problem at the router or gateway interface, a cable fault between the eth1 interface and the router or gateway interface, or a problem at the eth1 interface itself.

In one embodiment, the monitoring of the primary connection occurs by periodically polling the public interface eth1 and checking for responses. One method of polling involves sending ICMP (Internet Control Message Protocol) pings comprising 64-byte ICMP packets to one or more designated target IP addresses, for which an acknowledgement should be received if they successfully reach their target. It should be understood, however, that any other method of monitoring could be alternatively used in lieu of polling with ICMP packets. If no acknowledgement is received, this is assumed to indicate that the primary connection to cloud 80 is down.

The target IP addresses that are pinged may be any known IP addresses accessible over the Internet such as the IP address of a local gateway at the Internet service provider (ISP), the IP address of a gateway at Network 1, or an IP address of a particular server. Generally though, at least one target IP address to be pinged will include the IP address of the first router or gateway on the Internet that is closest to device 140. The particular IP addresses to be pinged will typically be related to the purpose of the monitoring. In one embodiment, at least two target IP addresses are pinged. This may include the IP address of the first router or gateway on the Internet that is closest to device 140 and an IP address for a network device that is further away from the eth1 interface.

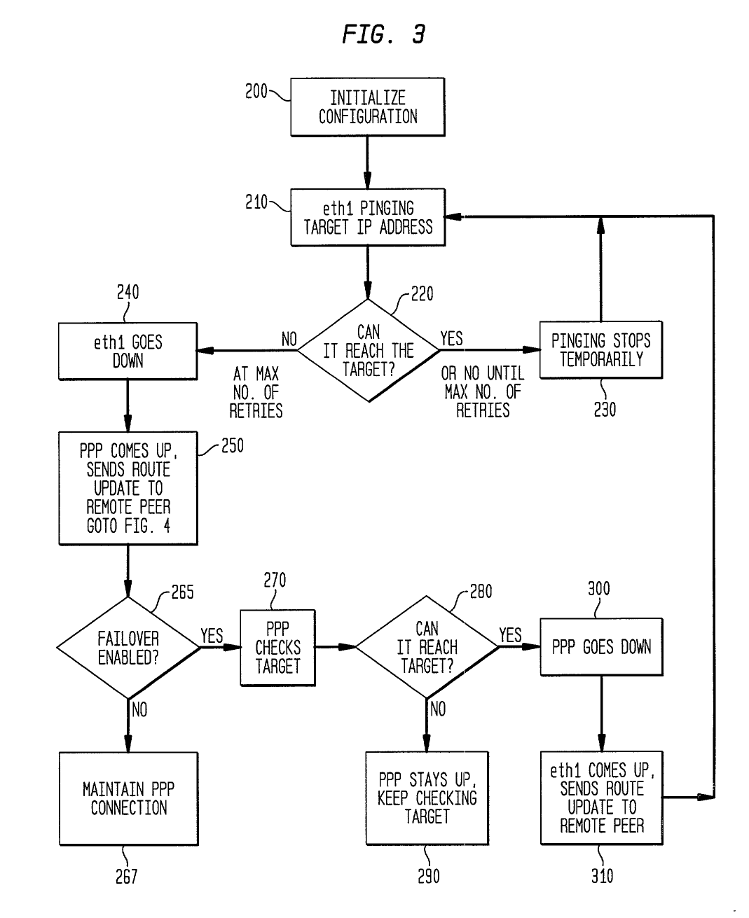

FIG. 3 is a flow chart illustrating the steps by which the system monitors for a failure of the primary connection and switches to the backup connection as necessary. At step 200, certain parameters are initially configured in the PPP daemon according to settings in a configuration file at device 140. These parameters include (1) first and second IP addresses to be monitored to determine whether the primary connection is available to connect to the public network; (2) the frequency of pings that should be sent per polling period; (3) the number of times the system should retry to reach the primary connection if the connection is not successfully pinged with a first series of pings; and (4) the delay between ICMP rounds of pings.

At step 210, for each of the two target IP addresses, an ICMP ping is sent n times with a frequency based on the value of the frequency parameter set in the configuration file. The results of the pings, i.e. whether a response is received to each ping, are stored into a local buffer 148 at device 140. The results are then analyzed at step 220. If the result of the n pings shows that the connection status is UP (e.g., all n pings were successful or at least most of them, depending on the system setting), then the pinging stops (“sleeps”) temporarily for a particular interval based on the setting of the delay value, at step 230. The pinging resumes at the end of the delay interval (step 210) with a series of n additional pings to again check the primary connection.

If, at step 220, it is determined that the result of the ICMP pinging is an invalid response and the value of the retry parameter has not yet reached the maximum value that has been set, then the connection status of the primary connection is set to DOWN, the “retry” count whose maximum value is set in the configuration file is incremented by 1, the invalid response is logged, and, after a timeout at step 230, the two target IP addresses are again polled with another series of n pings at step 210 to check whether a valid response is now received. The retry setting enables the system to essentially ignore momentary outages or system unavailability.

If, at step 220, it is determined that the results of the ICMP pinging of either target IP address is an invalid response or no response and the value of the retry parameter has reached the set maximum value (i.e. the retry count is exhausted), then the system assumes at step 240 that the primary connection is DOWN. At this point, pertinent information is logged such as the time and date of the failure, the DOWN connection status, and the dialing events such as the target addresses that were polled and the time of the unsuccessful poll. Also, at step 240, the Ethernet interface eth1 of device 140 is set to DOWN in device software, any security drivers such as the Fortress Tech SPS virtual security driver that runs in conjunction with eth1 on the Net Fortress family of products is set to DOWN, the PPPD is stopped if it was running, and a timeout period is provided to enable the stopping of the drivers and the new settings to take effect (a delay of approximately 3 seconds should be sufficient).

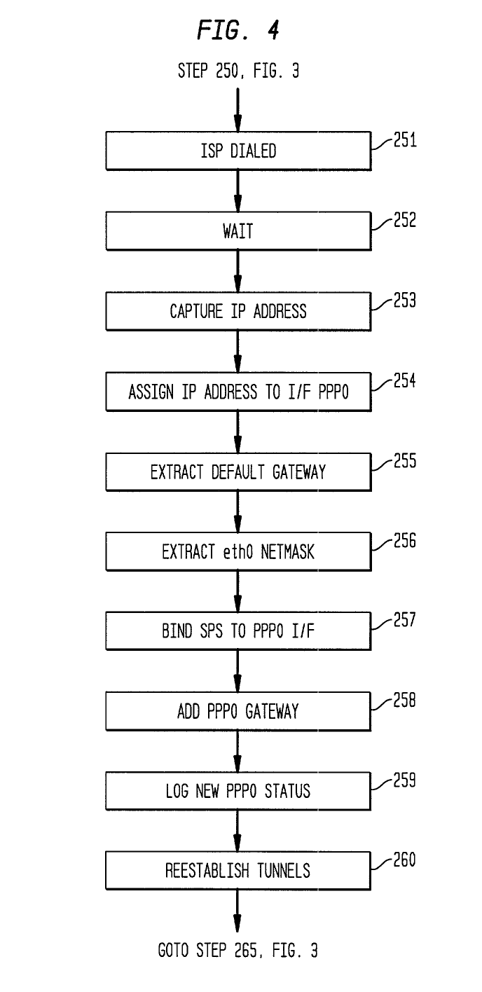

At step 250, the back-up connection is initiated and an alarm may be sent to the system administrator. Turning to FIG. 4, which is a flow chart providing further details about step 250, at step 251, the ISP is dialed using modem 150. At step 252, there is a waiting period for the connection to be completed (the length of which may possibly as long as approximately 40 seconds or longer, but it depends on the speed of the modem and the connection). Once the back-up connection is established by the ISP, at step 253, the IP address temporarily assigned to the back-up connection by the ISP (possibly by extracting it with an AWK script available for Unix) is captured and, at step 254, that address is assigned in software at device 140 to interface ppp0. At step 255, the ISP's default gateway for the ppp0 daemon is similarly extracted from the ISP. The eth0 's netmask (the network mask which shows how to divide an Internet address into network, subnet, and host parts and limits the values that may be placed in those fields) is also extracted at step 256 for use with the extracted IP address in setting up the tunnels for the VPN.

Also captured at step 256 is the eth1 setting for IP masquerading (enabled or disabled), which either enables or disables whether Network 2 can interact with a publicly accessible network device on the public network (set to enable) or can only interact with a device in the VPN (set to disable). If IP masquerading is enabled, network address translation is invoked to bind a network address translation table to the ppp0 interface instead of to the eth1 interface so that the same IP masquerading setting is automatically maintained at the ppp0 interface. The network address translation maps the private address of a VPN network device in a data packet to a routable address of a VPN for purposes of communicating with a device on the public network and vice versa for packets going in the opposite direction.

The Fortress Tech SPS protocol or other security protocol, if any, is bound with the ppp0 interface (step 257), a ppp0 default gateway is added (step 258), the new ppp0 status is logged in a log file to maintain a status record (step 259), and tunnels to the remote Network 1 side which had originally been established by the eth1 interface pursuant to the tunneling protocol that is used must be re-established but now with the ppp0 interface (step 260). Step 260 includes the task of notifying the remote peers to which the connection had been lost to use the new ppp0 interface in place of the original eth1 public IP interface. At this point, the back-up connection using the ppp0 interface is up and running, all routes, both secured and unsecured are re-established, and network traffic can resume, albeit, in this example, at the relatively slower speed of the back-up connection.

Returning to FIG. 3, with the back-up connection functioning, at step 265 it is determined whether the Failover daemon is enabled. If the Failover daemon is not enabled, then at step 267, the connection through the ppp0 interface is maintained until the primary connection is manually reset. A manual reset may be desirable to give the system administrator an opportunity to determine the source of the problem and to correct it. It also provides a way to prevent a “thrashing” condition in which multiple attempts are made to reconnect to the primary connection when the primary connection is not yet back up. Thrashing may occur, for example, where the primary connection failed due to a cable fault or a problem at the eth1 interface of device 140, but the target IP address is successfully pinged through the secondary back-up connection because the target IP address is a functioning gateway interface nearest the non-working eth1 interface.

If the Failover daemon is enabled, the Failover daemon attempts at step 270 to detect when the primary connection has been restored. The Failover daemon may specify a time delay before attempting a reconnection through the eth1 interface of device 140 in order to enable a system administrator to try to resolve the problem. The Failover daemon continues to monitor the primary connection, for example, by periodically sending a series ICMP pings through the ppp0 interface to the target IP address. If the pings do not reach the target as determined at step 280, the back-up connection is maintained at step 290. If the pings do reach the target, the successful pinging may be logged, the ppp0 interface is disconnected, and the Back-up daemon is exited at step 300.

The primary interface is re-established using a “fallback” utility at step 310. This fallback utility sets the Ethernet interface eth1 of device 140 to UP, sets any security drivers such as the Fortress Tech SPS virtual security driver that runs in conjunction with eth1 to UP, and a timeout period is provided to enable the stopping of the drivers and the new settings to take effect (a delay of approximately 3 seconds should be sufficient). If IP Masquerading is enabled, it is invoked to bind a network address translation table to the eth1 interface instead of the ppp0 interface. (If the masquerading is off, the netmask is only associated to the target IP address.) The SPS protocol or other security protocol, if any, is again bound with the eth1 interface. Also at step 310, all secured routes are redirected to the original primary interface and tunnels are re-established to the remote peers including the sending of route updates. The algorithm then returns to step 210 to monitor the status of the primary eth1 interface.

The above-described algorithm may be substantially described in pseudo-code as follows:

Initialize configuration:

Read DialBkup.cfg

Get_delay

If file does not exist or invalid data, log error and exit.

Get_addr 1

If invalid data, or address format, log error and exit.

Get addr 2

If invalid data, or address format, log error and exit.

Get_frequency

If invalid data, log error and exit.

Get_retries

If invalid data, log error and exit.

Create keep alive.log and write current time and date.

Main Processing Loop:

Send ping n times based on frequency value to addr 1.

Send ping n times based on frequency value to addr 2.

Read result into local buffer.

If results=valid response, from both destinations,

Set connection status to UP

Sleep for n interval based on delay value

Repeat polling loop.

Else if results=invalid response,

Set connection status do DOWN

If retry count !=max,

Increment retry count

Log the request timeout

Repeat polling loop.

Else

Log time and date of failure

Log connection status

Log Dialing events

Set eth1 interface to DOWN

Set sps interface to DOWN

Ensure pppd was not running If running, stop it.

Wait 3 seconds for processes to stop

Initiate ISP dial up

Wait for connection to complete (sleep 40)

Get IP for ppp0 interface

Get pp0's default gateway

Get eth0's netmask

If IP Masquerading enabled, Invoke it.

Configure sps with new public IP (ppp0 )

Add ppp0 default gateway

Log new ppp0 status

Call nfroute to re-establish tunnels on remote side. Notify remote peers to use new ppp0 IP In place of original eth1 public IP.

(cmd: nfroute -v -n [private net] -m [private net

mask] -g [ppp0 IP address] -s [public IP of remote peer]

Restart local nfd to re-establish tunnels to remote Peers. (cmd: kill -HUP nfd.pid)

If configured, invoke eth1 fallback.

Exit dial backup utility.

Fall Back Utility

Gate Poll Sequence

If fallback enabled

Ping fallback gateway addr1 and addr2

Else

Exit.

If both fallback gateways==ALIVE

Run /etc/ppp-off

Ifconfig sps down

Kill -9 nfd.pid's

Run /etc/init.d/network script

Call nfroute to re-establish tunnels on remote side.

Notify remote peers to use our eth1 IP

In place of the previous ppp0 public IP.

(cmd: nfroute -v -n [private net] -m [private net mask] -g [eth1 IP address] -s [public IP of remote peer]

Else

Wait for next gateway poll sequence.

Configuration

Configuration information for ppp and polling is stored in the following files: /etc/ppp/DialBkup.cfg

Delay=n Where n=delay time in seconds

Idaddr1=addr1 Where addr=a standard IPV4 address in dot notation

Iaddr2=addr2 Where addr=a standard IPV4 address in dot notation

Retry=n Where n=the number of times to retry a polling sequence before Determining a connection is down.

Frequency=n Where n=the number of consecutive pings to send in 1 polling Sequence.

/etc/ppp/ppp-on

ACCOUNT=Username assigned by the ISP

PASSWORD=Username's account password

TELEPHONE=ISP's telephone number

Dial Backup Component Files Used

| File and Location | Description |
|---|---|
| /etc/pppDialBkup.cfg | Dial backup polling parameters. |
| dialbkup | The dial backup utility which is the executable |
| | created at compile time. |
| /etc/ppp/getip | An awk script used to extract the dynamic IP |
| | address assigned by an ISP. |
| /etc/getgw | An awk script used to extract the ppp0 gateway. |
| /etc/getnm | An awk script used to extract eth0's netmask |
| /etc/ppp/ppp-on | The pppd startup script called by dialbkup when |
| | establishing a ppp connection. |
| /etc/ppp/ppp-off | The pppd script called to kill the current ppp ISP |
| | connection. |
| /etc/ppp/ppp-on-dialer | The ppp script used to communicate with the |
| | external modem attached to COM1. |
| /tmp/dbon | Indicator file used by cron to start dialbkup. |
| /tmp/keepalive.log | The log file created by the dialbkup utility at start |
| | time. Information is also stored in the |
| | /var/log/messages file. |
| /tmp/LOCAL_IP | A text file use to store the current ppp IP address |
| | assigned by an ISP. This file is created by the |
| | getip awk script. |
| /tmp/GATEWAY | A text file used to store the ppp0 gateway address |
| | assigned by an ISP. This file is created by the |
| | getgw awk script. |
| /tmp/NETW | A text file used to store the private eth0 network |
| | address. This information is used if IP |
| | masquerading is enabled and is created by getnm. |
| /tmp/NETMASK | A text file used to store the private eth0 network |
| | mask. This information is used if IP |
| | masquerading is enabled. |
| /tmp/keepalive | The file created by the dialbkup utility which |
| | stores responses received during a polling |
| | sequence. |
| dialbkup.c | The “C” source file for dialbkup. |

While there have been shown and described and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention. For example, although not illustrated, it should be understood that network translation device 70 may also have a secondary backup interface. It is expressly intended that all combinations of those elements which perform substantially the same function in substantially the same way to achieve the same results are within the scope of the invention. It is the intention, therefore, to be limited only as indicated by the scope of the claims appended hereto

What is claimed is:

1. A network interface device comprising:
a primary interface to interface with a public network over a primary connection;
a back-up interface to interface with the public network when the primary connection fails; and
a back-up utility for monitoring whether a primary connection between the primary interface and the public network has failed and for activating a secondary connection between the back-up interface and the public network when the primary connection fails.

2. The network interface device of claim 1, wherein the primary and back-up interfaces link a node of a virtual private network to a public network.

3. The network interface device of claim 2, wherein the node comprises one of a computer and a network of computers, and wherein the network interface device further comprises a private interface to the node.

4. The network interface device of claim 1, wherein the primary interface comprises an Ethernet interface.

5. The network interface device of claim 4, wherein the back-up interface comprises a dial-up interface to the public network.

6. The network interface device of claim 5, wherein the public network is the Internet and the dial-up interface is connected to an Internet service provider upon a failure of the primary connection.

7. A method for automatically activating a back-up connection to a public network when a primary connection to the public network fails, the method comprising:
providing a network interface device comprising a primary interface to interface with a public network over a primary connection, and a back-up interface to interface with the public network when the primary connection fails;
monitoring the primary interface to determine whether the primary connection has failed; and
automatically connecting to the public network through the back-up interface to provide a secondary connection thereto when the primary connection fails.

8. The method of claim 7, wherein the step of monitoring the primary interface comprises periodically polling a target IP address through the primary interface.

9. The method of claim 8, wherein the polling comprises sending ICMP pings to the target IP address.

10. The method of claim 7, wherein the back-up interface is connected to a modem, and wherein the step of automatically connecting to the public network through the back-up interface comprises automatically dialing an Internet service provider with the modem.

11. The method of claim 7, further comprising:
activating the secondary connection by rerouting links in the network interface device from the primary interface to the back-up interface to enable the secondary connection.

12. The method of claim 7, further comprising:
determining whether the primary connection can be restored;
restoring the primary connection when possible, the restoring of the primary connection comprising disconnecting the secondary connection.

13. The method of claim 12, wherein the restoring step comprises automatically restoring the primary connection.

14. The method of claim 12, wherein the primary and secondary connections connect nodes of a virtual private network that uses tunnels to send data securely over the public network, and wherein the method further comprises re-establishing tunnels for the virtual private network through the back-up interface when the primary connection fails.
